(19) United States
(12) Patent Application Publication
(10) Pub. No.: US 2003/0116665 A1
(43) Pub. Date: Jun. 26, 2003

(54) Arrangement facilitating single fastener attachment for strikers of a wood comminuting rotor

(76) Inventor: Anders Ragnarsson, Chester, NH (US)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 10/360,950

(22) Filed: Feb. 6, 2003

Related U.S. Application Data
(63) Continuation-in-part of application No. 09/885,635, filed on Jun. 20, 2001, now Pat. No. 6,520,440.
Application No. 09/885,635 is a continuation-in-part of application No. 09/635,320, filed on Aug. 9, 2000, now Pat. No. 6,394,378.

(51) Int. Cl. B02C 13/28

(52) U.S. Cl. 241/294

(57) ABSTRACT

A comminuting striker assembly for mounting on a rotor of a comminuting apparatus comprising: a striker having first and second opposed faces, the first face defining at least one cutting edge, and a striker retainer, the striker and striker retainer defining cooperating primary support surfaces and cooperating alignment components.

### RELATED APPLICATION

This is a continuation-in-part of copending patent application Ser. No. 09/885,635 filed Jun. 21, 2001 which is a continuation-in-part of patent application Ser. No. 09/635,320 filed Aug. 9, 2000.

### FIELD OF THE INVENTION

The invention provides an improved striker attachment for wood comminuting rotors which facilitates a keyed attachment enabling both a single fastener to be utilized attaching the striker to the striker retainer, and rapid removal and replacement of the striker.

### BACKGROUND OF THE INVENTION

Prior art comminuting apparatus for reducing large diameter wood products and stumps to a desired size, have comprised a reduction chamber, with an impact rotor positioned concentrically therein, in combination with a housing, drive motor and infeed chute. The impact rotor is formed with a plurality of horizontally elongate impact strikers at its periphery. The rotor is positioned so that the elongate wood product or stump falling under the influence of gravity through the infeed chute is directed against the strikers, and repelled ahead of the rotor's rotational direction against an anvil formed along one side of the reduction chamber.

Prior art wood comminuting apparatus are often capable of comminuting trees or parts thereof up to 40 inches in diameter (see e.g. U.S. Pat. No. 5,165,611). Strikers used for the comminution are bolted directly to mounting projections on the rotor which is rotated to produce the comminution. Maintenance to change strikers has required complete removal of the striker mounting bolts with the consequent potential loss of bolts and uneconomical use of maintenance time, especially in view of the substantial number of strikers on a rotor of such apparatus. Strikers of the prior art are typically fastened with two (2) hex head or similar studs, stud-bolts or bolts, relying on fastener torque to position and retain the strikers, resulting in the above noted potential loss of bolts and uneconomical use of maintenance time.

### SUMMARY OF THE INVENTION

It is an object of the invention to improve maintenance time and ease of striker replacement in comminution apparatus minimizing the potential for loss of components including fasteners.

It is a further object of the invention to improve the support and alignment of the strikers for initial installation of the strikers, during operation of the comminuting device, and during maintenance or replacement of strikers.

According to the invention there is provided a comminuting striker assembly for mounting on a rotor of a comminuting apparatus, the comminuting striker assembly comprising:

a striker having first and second opposed faces with the first face defining at least one cutting edge, and the second face of the striker having a cooperating surface; and

a striker retainer having a retainer base for attachment to a rotor and a leading face for attachment to the striker, the leading face having a striker support surface for engaging with the cooperating surface of the striker to provide primary support for the striker; wherein

the second face of the striker defines an alignment component while the leading face of the striker retainer defines a complimentary alignment component arrange to mate with the alignment component of the striker and to facilitate desired alignment of the striker with the striker retainer.

Also according to the invention there is provided a comminuting striker assembly for mounting on a rotor of a comminuting apparatus, the comminuting striker assembly comprising:

a striker having first and second opposed faces with the first face defining at least one cutting edge, and the second face of the striker having a cooperating surface; and

a striker retainer having a retainer base for attachment to a rotor and a leading face for attachment to the striker, the leading face having a striker support surface for engaging with the cooperating surface of the striker to provide primary support for the striker; wherein

one of the second face of the striker and the leading face of the striker retainer defines a first slot and the other of the second face and the leading face defines a complimentary first key arrange to engage the first slot thereby to facilitate proper alignment of the striker with the striker retainer, with the first slot and first key extending perpendicular to the cooperating surface and the striker support surface.

When the first key and the first slot are engaged, a single bore extends through the striker retainer from the leading face to a following face of the striker retainer; and a threaded fastener extends through the single bore in the striker retainer to the striker from the following face to attach the striker to the striker retainer by the use of a corresponding threaded bore in the striker. Preferably the corresponding threaded bore of the striker is a blind bore which opens to the second face of the striker but does not extend through the striker to the first face of the striker. In addition, according to the invention, one of the second face of the striker and the leading face of the striker retainer defines a second slot extending perpendicular to the first slot and the other of the second face and the leading face defines a complimentary second key arranged to engage the second slot thereby additionally to facilitate proper alignment of the striker with the striker retainer.

According to the invention there is also provided a method of mounting a comminuting striker assembly on a rotor of a comminuting apparatus, the method comprising the steps of:

providing a striker with first and second opposed faces with the first face defining at least one cutting edge, and forming a cooperating surface in the second face of the striker; and

providing a striker retainer with a retainer base for attachment of the comminuting striker assembly to a rotor and with a leading face for attachment of the striker to the striker retainer, forming the leading face with a striker support surface for engaging with the cooperating surface of the striker to provide primary support for the striker; and

the second face defining an alignment component;

leading face defining a complimentary alignment component arrange to mate with the alignment component of the striker to facilitate desired alignment of the striker with the striker retainer.

Also according to the invention there is provided a method of mounting a comminuting striker assembly on a rotor of a comminuting apparatus, the method comprising the steps of:

providing a striker with first and second opposed faces with the first face defining at least one cutting edge, and forming a cooperating surface in the second face of the striker; and

providing a striker retainer with a retainer base for attachment of the comminuting striker assembly to a rotor and with a leading face for attachment of the striker to the striker retainer, forming the leading face with a striker support surface for engaging with the cooperating surface of the striker to provide primary support for the striker; further comprising the steps of:

defining a first slot in one of the second face of the striker and the leading face of the striker retainer and defining a complimentary first key on the other of the leading face of the striker retainer and the second face of the striker arrange to engage the first slot to facilitate desired alignment of the striker with the striker retainer; the first slot and the first key extending perpendicular to the cooperating surface and the striker support surface.

In addition according to the invention, preferably a single bore is extended through the striker retainer from the leading face to a following face thereof;

a corresponding threaded bore is formed into the striker from the second face of the striker;

a threaded fastener is provided; and

the threaded fastener is passed through the single bore of the striker retainer from the following face of the striker retainer to the striker to attach the striker to the striker retainer by the use of a corresponding threaded bore in the striker. Also preferably the corresponding threaded bore in the striker is formed as a blind bore opening to the second face of the striker which does not extend through the striker to the first face of the striker.

### BRIEF DESCRIPTION OF THE DRAWINGS

The invention will now be described, by way of example, with reference to the accompanying drawings, in which:

FIG. 1 is an orthogonal view of a rotor with a plurality of strikers and retainers mounted thereto, showing two types of strikers;

FIG. 2 is a sectional end view of a rotor of the present invention showing two types of strikers attached to the rotors by way of retainers and bases;

FIG. 3 is a perspective view of a preferred embodiment two edged striker with cruciform key slots, and a single fastener hex opening;

FIG. 4 is a side elevation of the striker of FIG. 2;

FIG. 5 is a rear view of the striker of FIG. 2 showing the cruciform key slots;

FIG. 6 is a perspective view of a striker retainer according to the present invention with male cruciform keys to engage the cruciform key slots;

FIG. 7 is a front elevation of the striker retainer of FIG. 6;

FIG. 8 is an alternative embodiment single tooth striker according to the invention;

FIG. 9 is an elevation of a further embodiment of striker and striker retainer of the present invention shown assembled and bolted together;

FIG. 10 is a perspective view of the striker retainer shown in FIG. 9; and

FIG. 11 is a perspective of the striker shown in FIG. 9.

### DETAILED DESCRIPTION OF THE EMBODIMENTS

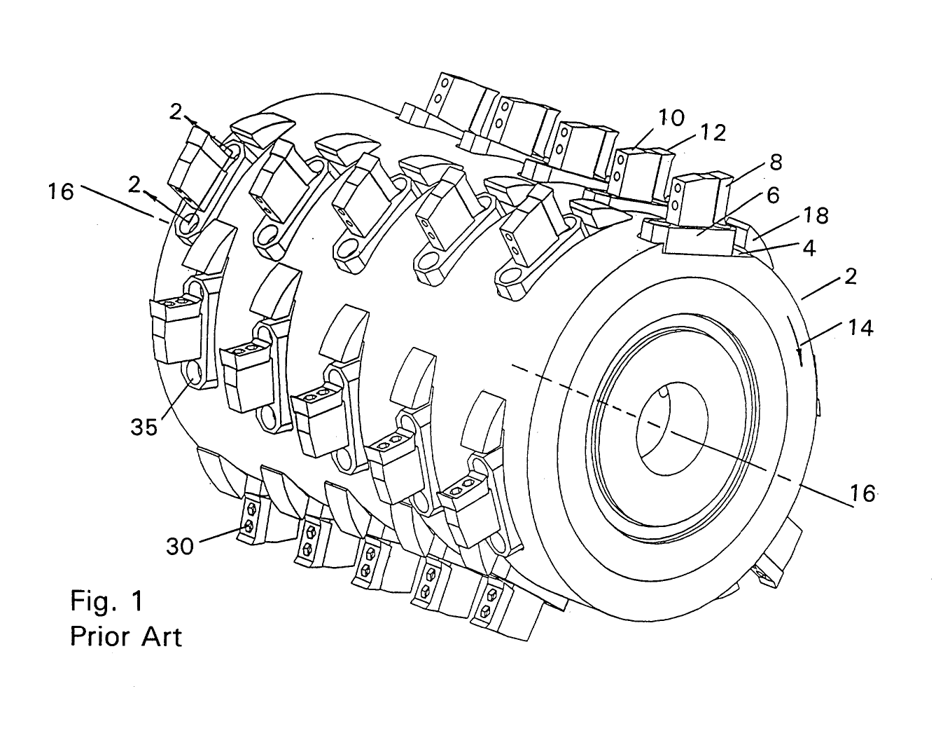

Referring to FIG. 1, a prior art assembly of rotor 2 of a wood comminutor defines striker carrying faces 4 for supporting a retainer bases 6 which supports strikers 8 by way of striker retainers 10 against comminuting forces during comminution with the face 4 and cutting edge 12 of the striker 8 facing in the direction of rotor rotation 14 about rotor axis 16. Projections 18 on the rotor 2, one for each striker 8, direct a work piece (not shown) into the cutting edge 12 of each striker 8 and away from striking the work piece facing side of retainer base 6. The configuration of strikers, striker retainers, and projections shown herein are based on prior art designs, and are therefore not discussed in detail herein.

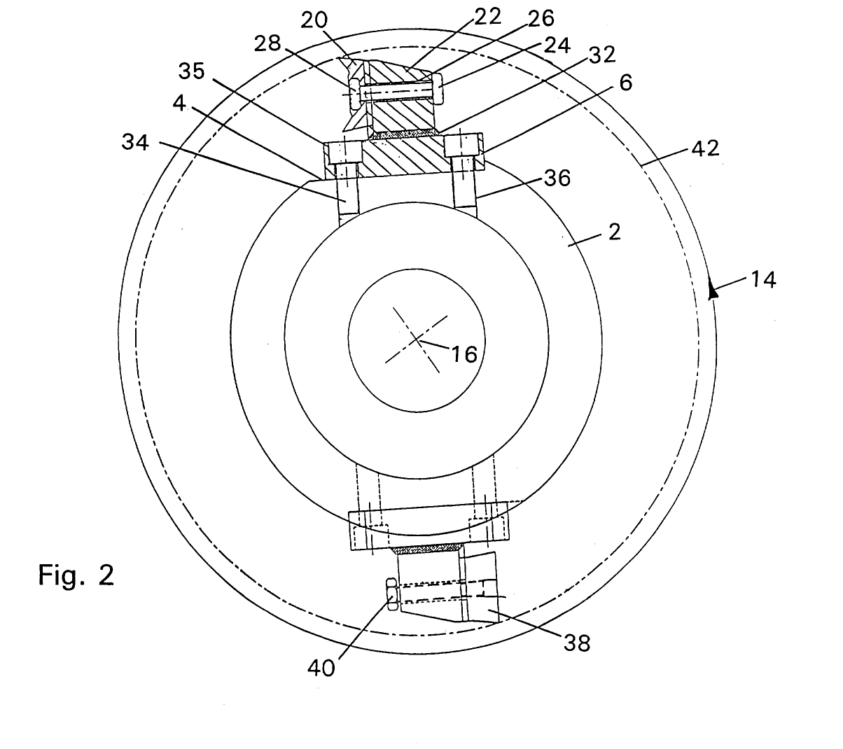

Referring to FIG. 2, the cruciform slot and key attachment of a striker 20 to striker retainer 22, of the present invention, is shown. The striker 20 is captively mounted to striker retainer 22 by a single bolt 28 extending through bore 26 to a nut 24 and fixed against rotation by a hex machined opening 30 in striker 20. Striker retainer 22 is captively mounted by a weld joint 32 to retainer base 6, which in turn is captively mounted to rotor 2 at retainer carrying face 4 by two bolts 34 extending through two countersunk bores 35 through retainer base 6 and mating threaded bores 36 in rotor 2.

Also shown in FIG. 2 is a second design of striker 38 which has a blind threaded hole for accepting bolt 40. The arc of striker rotation 42 is shown in FIG. 2.

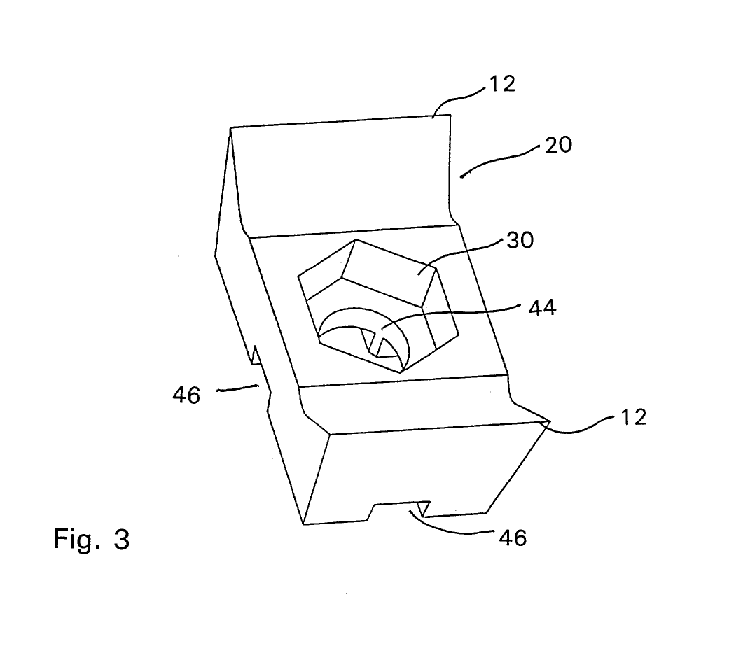

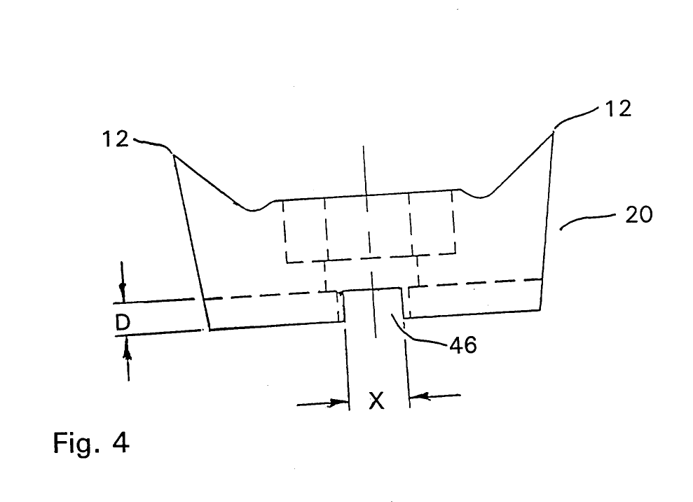

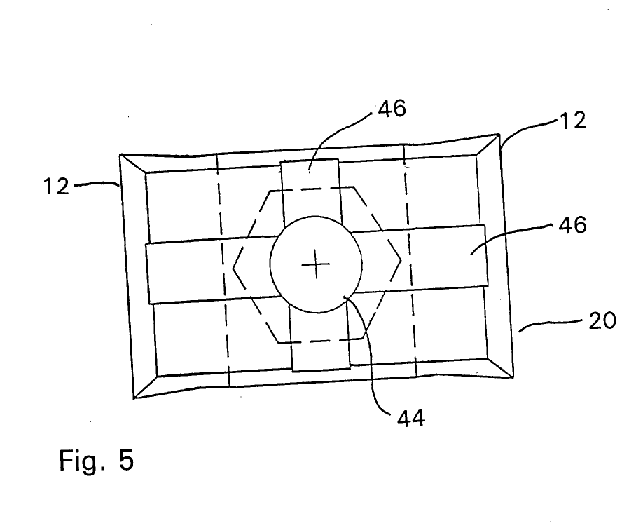

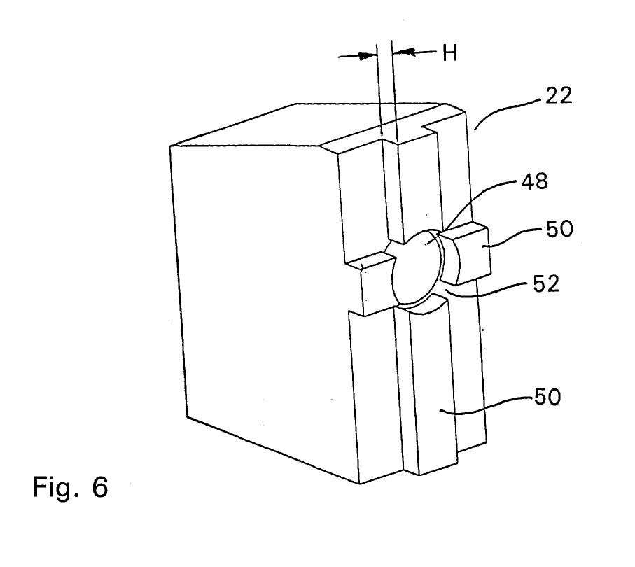

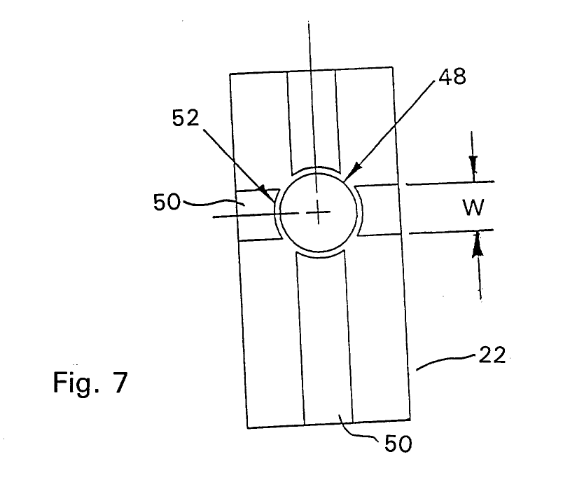

Referring to FIGS. 3, 4 and 5, preferred embodiment two edged striker 20 is shown. Cutting edges 12, hex shaped machined recessed opening 30, bolt clearance bore 44, and slots 46 are shown. Two slots 46 are machined perpendicular to each other and each centrally aligned with a centerline of clearance bore 44. The width X of slots 46 are machined to matingly receive the machined keys 50 of a striker retainer 22 (FIGS. 6 and 7), with a tight clearance fit. A tight clearance fit ensures minimal twisting motion is permitted between the striker and striker retainer. The machined depth D of slots 46 are equal to at least the height H of mating keys 50 shown in FIGS. 6 and 7 to ensure complete engagement of keys 50 within slots 46.

Referring to FIGS. 6 and 7, a striker retainer 22 is shown, with the raised machined keys 50, machined to mate in a tight clearance fit with the slots 46 of striker 20. Striker retainers are shaped to have a relatively tall leading face to which the striker is attached, and a relatively short opposed following face, which allows clearance between the work piece in contact with the striker cutting edge and the shorter face, such that only the cutting edge directly contacts the work piece. A relatively larger diameter counterbore 52 than the diameter of bore 48 is machined in central alignment with bore 48 to a counterbore depth which is at least the height H of keys 50. Counterbore 52 eliminates the machining difficulty of squaring the inside corners of keys 50 where the keys 50 intersect bore 48. This ensures mating alignment between keys 50 and slots 46 for the entire height H of keys 50. Key width W is machined on striker retainer 22 for the tight clearance fit with slots 46 discussed herein. Bore 48 is shown vertically off center of striker retainer 22 in FIG. 7, to provide a desired clearance of the bore from the retainer base 6.

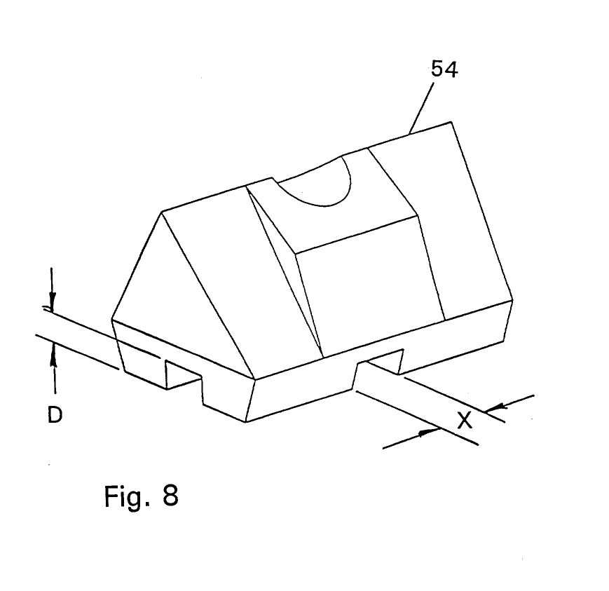

FIG. 8 is an alternative embodiment of a striker having a cutting edge 54 rotated 90 degrees compared to cutting edges 12 of FIG. 3, and including the cruciform slots of the present invention.

In use, slots 46 in striker 20 mate with the keys of striker retainer 22 such that motion between the mating faces of striker 20 and striker retainer 22 is minimized and alignment is assured. While connecting the striker 20 to striker retainer 22, the head of a hex bolt 28 is matingly positioned in hex machined opening 30. The bolt 28 connects with nut 24. Bolt 24 extends through clearance bore 44 in striker 20 and through bore 26, to threadably engage with hex nut 24. Torquing hex nut 24 to bolt 28 mechanically fastens striker 20 and striker retainer 22.

When the first of striker 20 cutting edges 12 becomes dull through use, nut 24 is removed, striker 20 is lifted away from striker retainer 22 until the slots 46 and keys 50 no longer engage, and striker 20 is rotated 180 degrees and its slots 46 re-mated to keys 50 of striker retainer 22. Nut 24 and bolt 28 are then re-threaded and torqued to complete the reassembly. If both cutting edges 12 of striker 20 become dull from use, and resharpening or replacement of striker 20 is required, the above steps to remove and reassemble striker 20 are applied, eliminating the rotation step.

It is desirable to rotate a sharp cutting edge 12 into position by loosening, but not totally removing, nut 24 from bolt 28. This prevents loss of either or both nut 24 and bolt 28, and speeds up this maintenance evolution.

The preferred embodiment of the invention includes cruciform shaped, or two (2) perpendicular slots, mating with two (2) perpendicular raised keys. Other forms of slot and key attachment are feasible, including but not limited to a single slot and mating key, more than two slots and mating keys, and slot/key combinations machined transversely. It will be understood that the use of at least one slot and key combination provides a face to face horizontal locking means between the striker and striker retainer which enables use of a single fastener or fastening technique to be applied to positively join the faces of the striker and striker retainer of a comminuting device.

It should also be understood that the items receiving the slot and key may be reversed. In the claimed invention, the striker may therefore have a raised key or keys in place of the female slot(s), and the striker retainer may have a slot or slots in place of the male key(s). The raised keys, if more than one is employed, would then be counterbored as noted herein. Other aspects of the claimed invention would remain similar to those described herein.

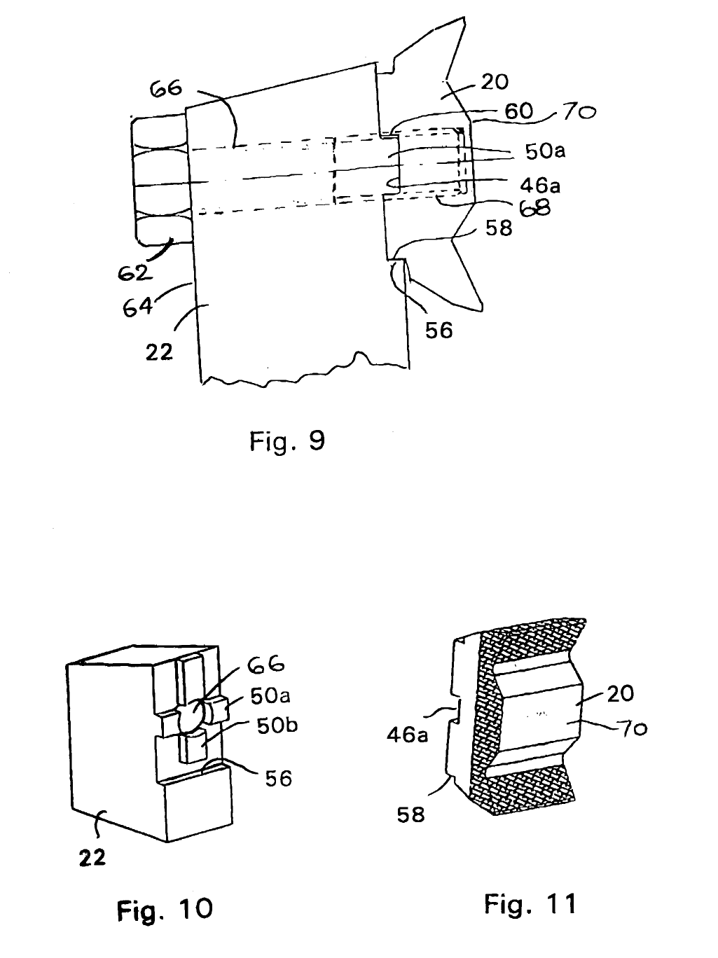

Referring now to FIGS. 9, 10 and 11, an alternative embodiment of striker 20 and striker retainer 22 is shown in which, when assembled together (FIG. 9), an upward facing surface 56 on the retainer 22 provides primary support for the striker 20 by virtue of the engagement of the surface 56 with a corresponding surface 58 machined in the striker 20. This primary support is facilitated by the provision of a clearance 60 (e.g. 0.010 inch) between the machined key 50a of the striker retainer 22 and the corresponding slot 46a in the striker, this clearance 60 is between the upwardly facing surface of the key 50a and the downwardly facing surface of the slot 46a (as seen in the orientation of the assembly in FIG. 9).

The key 50a and slot 46a are designed to provide a secondary support for the striker when wear of the striker 20 sufficient to reduce the clearance 60 to zero has occurred.

To facilitate this embodiment the key 50b is foreshortened.

The striker 20 is attached to the striker retainer 22 by a threaded bolt 62 extending from the following face 64 of the striker retainer through a single bore 66 to attach the striker 20 to the striker retainer 22 by the use of bore 68 having a thread corresponding to the thread of the bolt 62. To prevent damage to the threaded bore 68 and the end of the bolt adjacent the first face 70 of the striker 20, the threaded bore 68 is preferably terminated to form a blind bore which does not extend to the first face 70 of the striker.

Preferably the striker 20 has carbide surfaces as shown by cross-hatching in FIG. 11.

Except as described with reference to FIGS. 9, 10 and 11 the other features of this embodiment are similar to the embodiment described with reference to FIGS. 2-7 and will therefore not be described again here.

Reference Numerals

| | |
|---|---|
| 2 | rotor |
| 4 | retainer carrying face |
| 6 | retainer base |
| 8 | striker |
| 10 | striker retainer |
| 12 | striker cutting edge |
| 14 | rotor rotation |
| 16 | rotor axis |
| 18 | projection |
| 20 | modified striker |
| 22 | modified striker retainer |
| 24 | nut |
| 26 | bore |
| 28 | bolt |
| 30 | hex machined opening |
| 32 | weld joint |
| 34 | bolt |
| 35 | countersunk bore |
| 36 | threaded bore |
| 38 | alternative striker |
| 40 | bolt |
| 42 | striker arc |
| 44 | clearance bore |
| 46, 46a | slot |
| 48 | bore |
| 50, 50a, 50b | raised keys |
| 52 | counter bore |
| 54 | striker cutting edge |
| 56 | upward facing surface |
| 58 | corresponding surface |
| 60 | clearance |
| 62 | threaded bolt |
| 64 | following face |
| 66 | single bore |
| 68 | threaded bore |
| 70 | first face |
| D | slot depth |
| H | key height |
| X | slot width |
| W | key width |

We claim:

1. A comminuting striker assembly for mounting on a rotor of a comminuting apparatus, the comminuting striker assembly comprising:
a striker having first and second opposed faces with the first face defining at least one cutting edge, and the second face of the striker having a cooperating surface; and
a striker retainer having a retainer base for attachment to a rotor and a leading face for attachment to the striker, the leading face having a striker support surface for engaging with the cooperating surface of the striker to provide primary support for the striker; wherein
the second face of the striker defines an alignment component while the leading face of the striker retainer defines a complimentary alignment component arrange to mate with the alignment component of the striker and to facilitate desired alignment of the striker with the striker retainer.

2. A comminuting striker assembly for mounting on a rotor of a comminuting apparatus, the comminuting striker assembly comprising:
a striker having first and second opposed faces with the first face defining at least one cutting edge, and the second face of the striker having a cooperating surface; and
a striker retainer having a retainer base for attachment to a rotor and a leading face for attachment to the striker, the leading face having a striker support surface for engaging with the cooperating surface of the striker to provide primary support for the striker; wherein
one of the second face of the striker and the leading face of the striker retainer defines a first slot and the other of the second face and the leading face defines a complimentary first key arrange to engage the first slot thereby to facilitate proper alignment of the striker with the striker retainer, with the first slot and first key extending perpendicular to the cooperating surface and the striker support surface.

3. The assembly according to claim 2, wherein one of the second face of the striker and the leading face of the striker retainer defines a second slot extending perpendicular to the first slot and the other of the second face and the leading face defines a complimentary second key arranged to engage the second slot thereby additionally to facilitate proper alignment of the striker with the striker retainer.

4. The assembly according to claim 2, wherein, when the first key and the first slot are engaged, a single bore extends through the striker retainer from the leading face to a following face of the striker retainer; and a threaded fastener extends through the single bore in the striker retainer to the striker from the following face to attach the striker to the striker retainer by the use of a corresponding threaded bore in the striker.

5. The assembly according to claim 4, wherein the corresponding threaded bore of the striker is a blind bore which opens to the second face of the striker but does not extend through the striker to the first face of the striker.

6. The assembly according to claim 2, wherein the second slot and second key extend parallel to the cooperating surface and the striker support surface, and a clearance between the second slot and the second key ensures provision of said primary support when the second slot and the second key are engaged.

7. The assembly according to claim 6, wherein the clearance is such that the second slot and the second key provide a secondary support for the striker when wear of the striker reduces the clearance to zero.

8. A method of mounting a comminuting striker assembly on a rotor of a comminuting apparatus, the method comprising the steps of:
providing a striker with first and second opposed faces with the first face defining at least one cutting edge, and forming a cooperating surface in the second face of the striker; and
providing a striker retainer with a retainer base for attachment of the comminuting striker assembly to a rotor and with a leading face for attachment of the striker to the striker retainer, forming the leading face with a striker support surface for engaging with the cooperating surface of the striker to provide primary support for the striker; and
the second face defining an alignment component;
leading face defining a complimentary alignment component arrange to mate with the alignment component of the striker to facilitate desired alignment of the striker with the striker retainer.

9. A method of mounting a comminuting striker assembly on a rotor of a comminuting apparatus, the method comprising the steps of:
providing a striker with first and second opposed faces with the first face defining at least one cutting edge, and forming a cooperating surface in the second face of the striker; and
providing a striker retainer with a retainer base for attachment of the comminuting striker assembly to a rotor and with a leading face for attachment of the striker to the striker retainer, forming the leading face with a striker support surface for engaging with the cooperating surface of the striker to provide primary support for the striker; further comprising the steps of:
defining a first slot in one of the second face of the striker and the leading face of the striker retainer and defining a complimentary first key on the other of the leading face of the striker retainer and the second face of the striker arrange to engage the first slot to facilitate desired alignment of the striker with the striker retainer; the first slot and the first key extending perpendicular to the cooperating surface and the striker support surface.

10. The method according to claim 9, further comprising the step of defining a second slot in one of the second face of the striker and the leading face with the striker retainer, with the second slot extending perpendicular to the first slot, defining a complimentary second key on the other of the second face and the leading face, the second key extending perpendicular to the first key and the slots arrange to engage with the keys to facilitate proper alignment of the striker with the striker retainer.

11. The method according to claim 9, further comprising the steps of extending a single bore through the striker retainer from the leading face to a following face thereof;
extending a corresponding threaded bore into the striker from the second face of the striker;
providing a threaded fastener; and
passing the threaded fastener through the single bore of the striker retainer from the following face of the striker retainer to the striker to attach the striker to the striker retainer by the use of a corresponding threaded bore in the striker.

12. The method according to claim 11, comprising forming the corresponding threaded bore in the striker as a blind bore opening to the second face of the striker and which does not extend through the striker to the first face of the striker.

13. The method according to claim 10, wherein the second slot and second key extend parallel to the cooperating surface and the striker support surface, and comprising the step of providing a clearance between the second slot and the second key to ensure provision of said primary support when the second slot and the second key are engaged.

14. The method according to claim 13, comprising the step of ensuring that the clearance provides a secondary support for the striker, by means of engagement of the second slot with the second key when wear of the striker reduces the clearance to zero.
